(19) United States
(12) Patent Application Publication
(10) Pub. No.: US 2025/0045153 A1
(43) Pub. Date: Feb. 6, 2025

(54) INTELLIGENT CHIPKILL MARKING

(71) Applicant: Micron Technology, Inc., Boise, ID (US)

(72) Inventors: Joseph M. McCRATE, Boise, ID (US); Kirthi SHENOY, Boise, ID (US); Marco SFORZIN, Cernusco sul Naviglio (IT); Brian M. TWAIT, Meridian, ID (US)

(73) Assignee: Micron Technology, Inc., Boise, ID (US)

(21) Appl. No.: 18/786,254

(22) Filed: Jul. 26, 2024

Related U.S. Application Data
(60) Provisional application No. 63/517,341, filed on Aug. 2, 2023.

(51) Int. Cl. G06F 11/10

(52) U.S. Cl. CPC G06F 11/1016; G06F 11/1068

(57) ABSTRACT

Provided herein is a memory system including logical to physical memory address translation logic to build up a minimum address space containing a memory device address with defects, the translation being based on memory correction attempts. For each correction attempt, the logical address is first translated to a memory device physical address and bit positions at the physical address are compared with an existing error bit pattern to determine if marking should be applied to the memory device. If the bit positions do not match the existing error bit pattern, but errors are corrected from the marked memory device, the existing error bit pattern will be updated to reflect a new error bit pattern.

### CROSS-REFERENCE TO RELATED APPLICATIONS

This application claims benefit to U.S. Provisional Patent Application No. 63/517,341, filed Aug. 2, 2023, the disclosure of which is incorporated herein in its entirety, by reference.

### FIELD OF TECHNOLOGY

The following relates generally to one or more systems for memory and improving reliability, availability, and serviceability (RAS) in the memory systems. In particular, the following relates to improved error correction code (ECC) schemes for detecting and correcting errors due to memory device failures.

### BACKGROUND

Memory devices (e.g., memory media devices) are widely used to store information in various electronic devices such as computers, user devices, wireless communication devices, cameras, digital displays, and the like. Information is stored by programing memory cells within a memory device to various states. For example, binary memory cells may be programmed to one of two supported states, often corresponding to a logic 1 or a logic 0.

In some examples, a single memory cell may support more than two possible states, any one of which may be stored by the memory cell. To access information stored by a memory device, a component may read, or sense, the state of one or more memory cells within the memory device. To store information, a component may write, or program, one or more memory cells within the memory device to corresponding states.

Various types of memory devices exist, including magnetic hard disks, random access memory (RAM), read-only memory (ROM), dynamic random access memory (DRAM), synchronous dynamic RAM (SDRAM), static RAM (SRAM), flash memory, and others. Memory devices may be volatile or non-volatile. Volatile memory cells (e.g., DRAM cells) may lose their programmed states over time unless they are periodically refreshed by an external power source. SRAM memory cells may maintain their programmed states for the duration of the system being powered on. Non-volatile memory cells (e.g., Not And (NAND) memory cells) may maintain their programmed states for extended periods of time even in the absence of an external power source.

Many memory devices comprise multiple memory components. For example, a single read or write operation from a memory controller transfers data from or to multiple memory components in parallel. Thus, a single access may comprise data stored across multiple memory devices.

Compute express link (CXL) DRAM memory devices generally require high RAS. One key reliability consideration is achieving a low annualized failure rate (AFR) and silent data corruption (SDC) rate. As known in the art, SDC occurs when a processor inadvertently corrupts the data it processes but the rest of the system is unaware of the inadvertent corruption. Lower AFRs may be achieved using ECC techniques capable of detecting and correcting errors due to failure of an entire memory component. However, these techniques can be costly in terms of parity bit requirements. These techniques are commonly known to those of skill in the art as chipkill.

Certain ECC schemes may be able to correct some error patterns with high probability, but not deterministically. This has been observed for error patterns which impact a single device for some conventional ECC approaches. Using these approaches, there is a finite probability of a decoder failure for these error patterns, which results in an uncorrectable error (UE) returned to the host.

As understood by a person of ordinary skill in the art, a UE occurs when an ECC decoder encounters an error pattern that it cannot resolve deterministically. This means that the ECC algorithm is unable to identify and correct the erroneous bits within the data, leading to a failure in data integrity. As a result, the system may return corrupted data to the host or trigger an error notification indicating that the data cannot be reliably retrieved or corrected.

There is a finite probability of a decoder UE on each memory read operation. Even if the decoder failure probability per read is low, the cumulative probability of at least one decoder failure will continue to grow with writes/reads if no action is taken. Thus such schemes often mark a failing memory device in the event an error pattern which cannot be deterministically corrected occurs. Marking an entire device as failed is not optimal for several reasons.

That is, most failures are localized and will impact only a small number of addresses or, for example, a single row. For many conventional correction schemes, applying the marking information will limit the correction capability for errors on other non-marked memory devices. Some implementations use various criteria and thresholds to determine when to mark (or un-mark) a device. However, this fails to avoid the problem of diminished correction capability on non-corrupted addresses on the problem device.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates a functional block diagram of a system including a host, a memory controller, and a memory array, according to an embodiment of the present disclosure.

FIG. 2 illustrates a flow chart of an exemplary logical physical address translation process, in accordance with an embodiment of the present disclosure.

FIG. 3A illustrates a schematic diagram of example logic with six address bits with read with all positions is required.

FIG. 3B. illustrates a schematic diagram of an example logic with six address bits with subsequent reads.

FIG. 4. illustrates an example graphical illustration with failures contained to single section in one bank.

FIG. 5. illustrates a flow chart for an exemplary initial error address capture process.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

The embodiments provide methods to successfully correct errors when either an entire device has failed or an entire read access to a device is corrupt using less costly (in terms of parity/die overhead) ECC schemes. The embodiments also provide a streamlined solution for minimizing the cumulative decoder failure probability due to multiple non-deterministic error corrections while avoiding unnecessarily reducing the correction capabilities of the code for most addresses.

Although the decoder failure probability may be very low for any single read, the cumulative failure probability from multiple writes/reads from failing addresses will eventually approach unity. As a result, a UE will eventually occur. Even for a single failing row, this row could be written to, or read from, thousands of times per second, meaning a cumulative failure could occur very quickly.

The embodiments provide an ECC solution that marks which memory device has failed, based on criteria, and uses the knowledge of this failure as erasure information in subsequent correction attempts. Erasure decoding (or error and erasure decoding) can correct more symbol errors deterministically compared with random error correction. The disclosure enables deterministic correction of reads after a device has been marked, preventing the growth in the cumulative failure probability.

Using erasure information reduces the capability to correct errors on other devices. For example, with a Reed-Solomon (RS) code there are a total of six (6) parity symbols. If each device contains four (4) symbols per codeword, then marking a device as failed effectively reduces the remaining parity to two (2) symbols, so that only one random symbol correction is possible.

The embodiments provide a simple solution which can minimize the cumulative decoder failure probability due to multiple non-deterministic error corrections while avoiding unnecessarily reducing the correction capabilities of the code for most addresses.

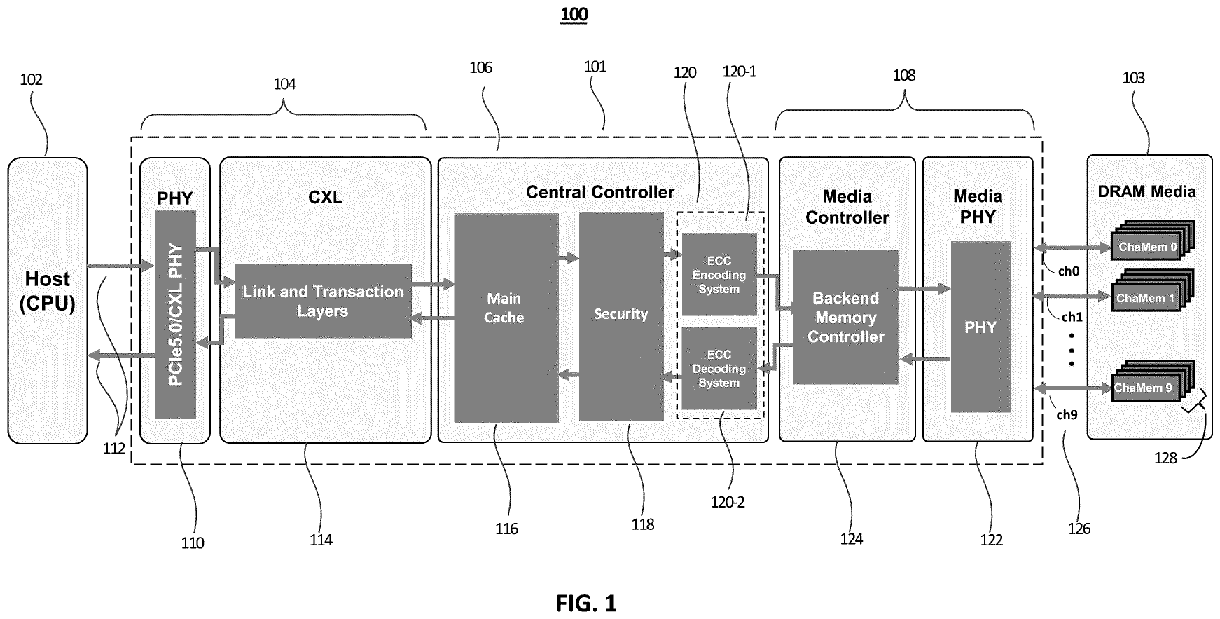

FIG. 1 illustrates a functional block diagram of a memory system 100 including a host, a memory controller, and a memory array, according to an embodiment of the present disclosure. For example, the system 100 includes a memory controller 101 for managing transfer of data, commands, and/or instructions between a host 102 and a memory device, such as DRAM media 103.

The memory controller 101 includes a front end portion 104, a central controller 106, and a backend 108. By way of example, the host 102 can be a central processor unit (CPU), personal computer, mobile telephone, an Internet-of-Things (IoT) enabled device, or the like. The host 102 can include processing resources (e.g., one or more processors, microprocessors, or other type of controlling circuitry) capable of accessing the DRAM media 103.

The front end portion 104 may include a physical interface 110 to couple the memory controller 101 to the host 102 through input/output (I/O) lanes 112. Interface management circuitry 114 manages the interface 110. For example, the interface 110 can include suitable protocols (e.g., a data bus, an address bus, and a command bus, or a combined data/address/command bus). Such protocols may be custom or proprietary, or may be standardized, such as the peripheral component interconnect express (PCIe), CXL, Gen-Z, cache coherent interconnect for accelerators (CCIX), or the like.

The central controller 106 can control, in response to receiving a request from the host 102, performance of a memory operation, such as reading/writing data from/to the DRAM media 103. The central controller 106 can include a main cache 116 to store data associated with performance of memory operation, and/or a security component 118 to encrypt the data before storage in the DRAM media 103.

The central controller 106 includes an ECC controller 120 to detect and correct n-bit errors that may occur in the data stored in the DRAM media 103. The ECC controller 120 includes an ECC encoding system 120-1 and an ECC decoding system 120-2. The ECC encoding system 120-1 executes encoding operations to encode the data written to the DRAM media 103. The ECC decoding system 120-2 executes decoding operations to decode the data read from the DRAM media 103.

Users are increasingly requiring that certain DRAM products have higher reliability so that a host, such as the host 102, can successfully retrieve the stored data. ECC techniques, such as chipkill noted above, are implemented to increase DRAM reliability. ECC chipkill protects data against any single DRAM component failure. As an example, an ECC technique may require additional parity bits to be stored, in addition to original user data bits. The need to store additional ECC parity bits, however, reduces the media capacity available to the host 102, increases overall costs, and increases power usage.

By way of background, a competing requirement is the ability to store other information, in addition to the ECC parity bits, on top of the original user data. CXL products, for example, are required to store metadata in certain circumstances. Thus, the need to store metadata conflicts with the need to store the additional ECC parity bits. Therefore, less costly ECC solutions (in terms of parity and die overhead) are needed to correct errors when an entire device fails or an entire read access to a device is corrupt.

An optimal ECC solution, in accordance with the embodiments, leverages (i) the ability to correct more erasures than random errors and (ii) the fact that most errors will likely be confined to a specific DRAM component. Stated another way, the odds of multiple DRAM components failing simultaneously is very low. Additionally, if the failure is a UE, then it is also likely the fault generating the UE is bounded to one faulty DRAM component.

ECC schemes capable of correcting errors using parity symbols, such as RS codes, are well known to those of skill in the art. By way of background, RS codes include a group of error-correcting codes that operate on a linear block of data called codewords. Codewords are of (n) length and include (k) data symbols, along with parity check symbols added to the data symbols, each symbol comprising (s) bits. There are (n)-(k) parity symbols. The parity check symbols enable RS codes to detect and correct multiple symbol errors.

For example, using 2(t) parity symbols, RS codes can correct combinations of erasures (v) and random errors (e) such that (v)+[(e)/2]≤(t). Additionally, a codeword may span j) devices, with (x) symbols per device such that the entire codeword (n)=(x)*(j) symbols.

As used herein, an erasure means that a specific symbol location for one or more bits is known to be corrupt (i.e., unknown error value). The location of a random error is unknown. All that is known is that data corruption occurred. As a result, if the location of the error is known, it is possible to correct more erasures than random errors. In fact, consistent with the expression above, twice as many erasures (v) can be corrected as random errors (e). More specifically, an RS based decoder can correct up to (t) errors or up to 2(t) erasures. Error correction attempts beyond these finite limits will generate a UE.

Conventional ECC techniques are generally unable to efficiently detect and correct failures in certain circumstances. Included in these circumstances are cases where an entire device fails and/or cases involving all bits in a given read from a single device. These circumstances are exacerbated when the ECC scheme is constrained to (e) errors being treated as random errors (i.e., no erasure information). These constraints cause the decoder to either indicate a failure, or correct the wrong codeword, resulting in SDC. ECC solutions constructed in accordance with the embodiments, however, remedy this and other deficiencies.

In the embodiments of the present disclosure, knowledge of erasure location is leveraged to identify a single faulty DRAM component based on other DRAM component(s) that were successfully decoded. Also, knowledge that faults leading to the corruption of multiple symbols in a codeword are likely confined to a single DRAM component significantly reduces the search space (i.e., possible error location combinations) required to identify the error location, compared to other ECC techniques. ECC solutions, in accordance with the embodiments, also decrease decoding delays and reduce the occurrence of false decoding errors.

Returning to FIG. 1, DRAM devices, such as the DRAM media 103, usually consist of identical DRAM components. Data may be stored to, and accessed from, multiple components in parallel. In these arrangements, the failure of any one component may corrupt data and result in errors. The ECC controller 120 implements an iterative decoding technique that corrects DRAM device failures and ultimately reduces the likelihood of such errors.

Using exemplary RS coding principles, the ECC encoding system 120-1 stores original user data (e.g., data bits) in memory in the form of a linear block code, known as a codeword. The codeword includes the original payload or user data bits, along with a set of ECC parity bits used to check for errors in the data bits. The host 102 may later request the memory controller 101 to retrieve the stored user data. In response, the ECC decoding system 120-2 reads the codeword from the DRAM media 103, decodes the codeword to correct any errors, and provides decoded data bits to the host 102.

The backend 108 may include multiple physical layer (PHY) 122 and a media controller 124 to drive an interface 126. The interface 126 couples the memory controller 101 to channel memory devices (ChaMem0-ChaMem9) within the DRAM media 103. By way of example only. and not limitation, the interface 126 includes data/parity channels (ch0-ch9) respectively corresponding to the channel memory devices (ChaMem0-ChaMem9). In one or more embodiments, the channels (ch0-ch9) may include low-power double data rate 5 (LP5) channels.

The channel memory devices (ChaMem0-ChaMem9) may be arranged in a plurality of layers of memory regions forming logical memory ranks 128, each rank including one or more die (i.e., components) therein. As understood by those of skill in the art, a memory rank includes a set of DRAM chips that can be accessed simultaneously via a common chip select.

In practice, the memory error patterns of concern to device performance do not impact the entire memory device. In most cases, these memory error patterns only impact a very small memory address space in the memory device. That is, physically, memory error patterns are localized and isolated to a small region within a memory device array, such as a particular one of the channel memory devices (ChaMem0-ChaMem9) within the DRAM media 103. Accordingly, instead of marking the entire memory device as failed, this approach enables much smaller areas (i.e. error patterns) within the physical memory addresses of the memory device to be marked as failed. Marking minimizes the number of error correction attempts, reserving the stronger ECC schemes for most of the remaining memory addresses within the particular memory device. As a result, this approach enables more error corrections to be performed and minimizes the risk that error correction attempts will generate UEs, To leverage the embodiments, a knowledge of the physical memory address translation is desirable.

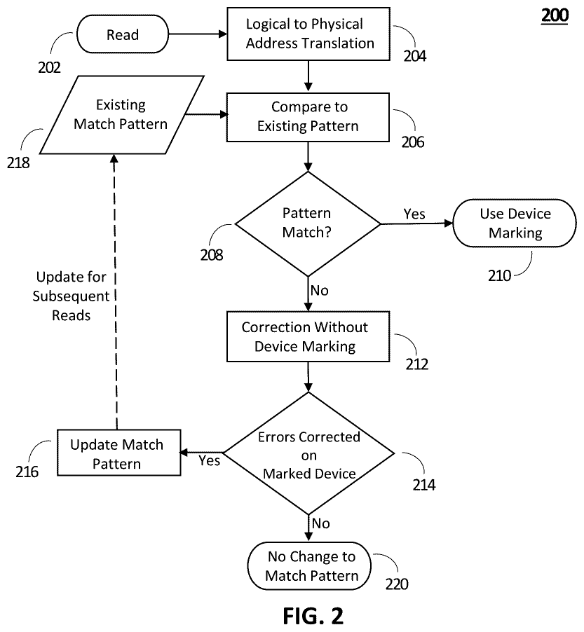

More specifically, a knowledge of the physical memory device address path is desirable, along with the location of all the bits corresponding to the particular memory device. This information helps to localize and isolate the error patterns and aids in defining the physical boundaries, or the minimum address space, of the error pattern. This process begins with performing a logical-to-physical address translation, as illustrated in FIG. 2.

FIG. 2 illustrates a flow chart of an exemplary logical-to-physical address translation process 200, in accordance with an embodiment of the present disclosure. In FIG. 2, as described above, the idea is to leverage the knowledge of the logical memory address to a physical memory address translation to build up a minimum address space that fully contains the memory addresses containing the errors. For each correction attempt (i.e. read with non-zero syndrome), the logical address is first translated to the memory device's physical address. The physical address is compared with an existing pattern (if prior errors were detected) to determine if device marking should be applied.

In the embodiments, the decoders (e.g., the ECC decoding system 120-2) use the location of the failing device discovered on the first correction to assist subsequent correction attempts to avoid a high cumulative failure probability. Data from the failing device is often treated as erasures in subsequent correction attempts, which enables more errors to be corrected versus random error correction. This preserves the full error correction capability for most addresses and greatly reduces the probability of generating UEs. The disclosure leverages knowledge of logical to device internal physical mapping and failure modes to minimize the impacted addresses.

In FIG. 2, a memory read (i.e., current read) operation 202 initiates the process by accessing a specific logical address in the DRAM media 103. This logical address represents the location of data to be read from the particular memory device within the DRAM media 103. The current read operation 202 is a step in memory access, where the memory system 100 retrieves the data stored at the specified logical address. The current read operation 202 triggers subsequent operations in the process, including physical memory address translation and error correction.

In block 204, the logical address obtained from the current operation 202 undergoes a translation process to convert the logical memory address into a physical memory address. This translation is necessary because memory systems use logical memory addresses for data access, which need to be mapped to physical memory addresses where the data is actually stored within the memory device. The translation process leverages the system's knowledge of the logical to physical address mapping, ensuring accurate data retrieval from the correct physical location in the particular memory device.

In block 206, the translated physical address is compared with a current error pattern stored in a register (discussed below) within the memory device. This error pattern represents previously detected error locations or failing memory address ranges. The comparison determines whether the current physical address matches one or more known error patterns. Thus, block 206 identifies whether the current read operation 202 is accessing a potentially problematic address range that has been marked for handling due to previous errors.

In block 208, the result of the pattern (match) comparison 206 is checked to determine if there is a match. If the physical memory address matches an existing error pattern (block 206), logic within the memory system 100 identifies this as a pattern match. This detection step is for deciding the subsequent error correction strategy. A pattern match indicates that the current read operation 202 is accessing a known failing address range, which requires specific error correction measures to prevent UEs.

Upon detecting a pattern match in block 208, the system proceeds to block 210, where device marking is implemented for the current read operation 202, and for subsequent correction attempts. Device marking involves treating the data from the identified failing address range as erasures during error correction. This approach leverages the knowledge of the failing address to enhance the error correction capability, allowing the system to correct more errors deterministically compared to random error correction. Device marking ensures reliable data retrieval from known problematic address ranges. That is, the memory device will be marked as failing for the current read 202.

If in block 208, the error pattern is not matched, the system proceeds to block 212, where the system performs error correction without memory device marking. In this scenario, the system treats the data as typical and applies standard ECC techniques without considering any specific failing address information. This step ensures the system can still correct errors in the data, even if the current read operation 202 does not match any known error patterns.

In block 214, a check is performed to determine whether errors were corrected (in block 212) on the marked device during the correction attempt. This step determines the effectiveness of the error correction process. If errors were successfully corrected on the marked device, the successful correction indicates that the device marking strategy was effective in handling the known failing address range. This check helps the system decide whether to update the error patterns for future memory read operations.

If errors were corrected on the marked device, the system proceeds to block 216, where the system updates the match pattern to reflect this new learning (i.e., updated error pattern information). This update involves modifying the existing error patterns based on the newly detected errors, ensuring that future memory read operations can benefit from the updated error information. Updating the match pattern is a dynamic process that enhances the system's ability to handle errors more effectively over time.

In block 218, the system uses the updated match pattern for subsequent read operations. This process ensures that the error information is applied to future read operations, improving the overall reliability of the memory system. By leveraging the updated match pattern, the system can more accurately identify and handle failing address ranges, reducing the risk of UEs in future data accesses.

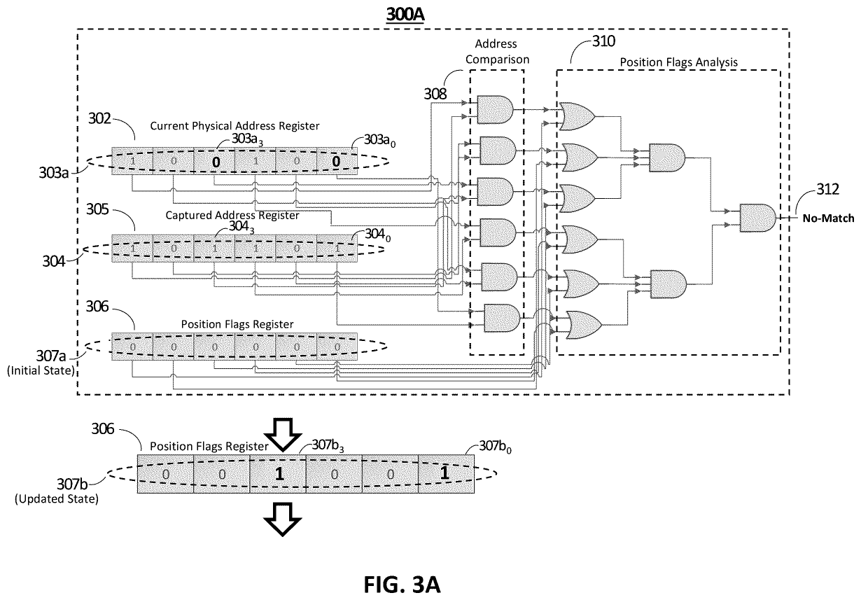

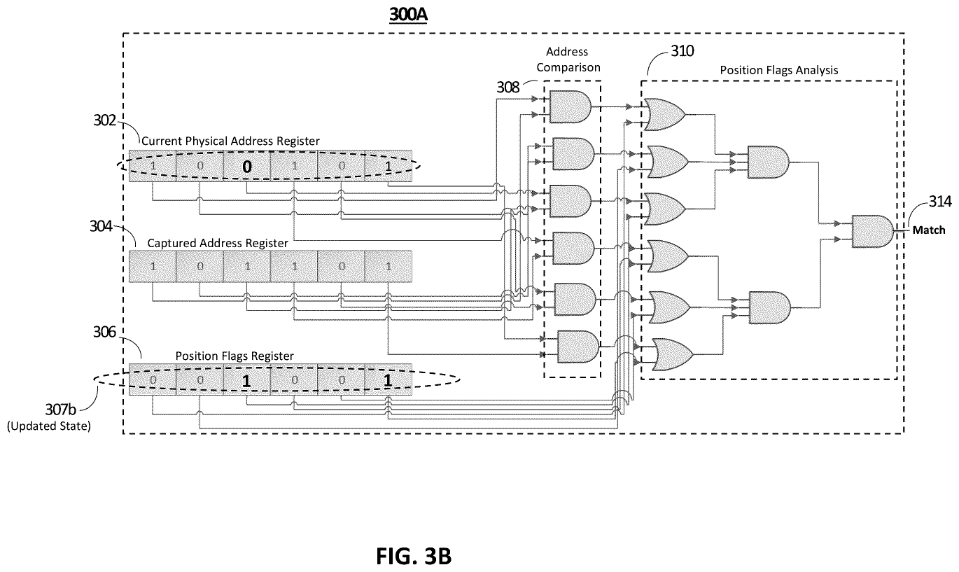

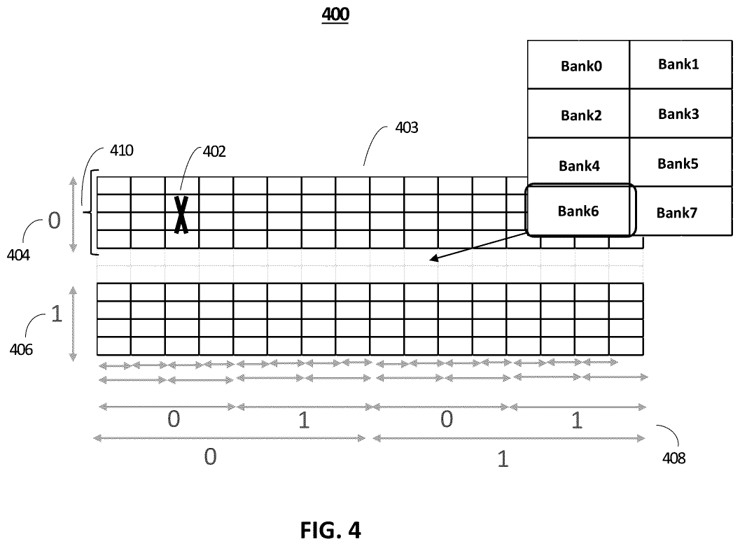

If no errors were corrected on the marked device in block 214, the system proceeds to block 220, where there is no change to the match pattern. In this scenario, the existing error patterns remain unchanged, and the system continues to use the current match pattern for future read operations. This step ensures the system maintains stability and consistency in error handling, even if no new errors were detected during the correction attempt. Additional details of pattern matching are provided below in the descriptions of FIGS. 3-4.

The embodiments learn the boundary of failing addresses with a bounded number of mistakes. Mistakes means not using device marking when the address represents errors on a failing device. By way of example, although there are 2^{N} memory addresses for a binary system, where N is the number of address bits, there are at most N reads attempted without device marking. N attempts would only be required if the entire memory device failed. By way of example only, and not limitation, N may typically be 15-20 which may be an acceptable number of attempts to avoid a large cumulative decoder failure probability.

Embodiments of the invention could use a looser criteria when all position flags (described below) less than and including the most significant non-matching position are updated. This approach would typically require fewer mistakes, although worst case remains the same. A physical address should account for hierarchy in the DRAM device (e.g., the DRAM media 103) to yield most effective results. It is desirable to identify the smallest region (number of address bits) required to completely bound the memory fails.

A match is detected when an incoming physical address matches a detected pattern for all required positions. A third register (e.g., A position flag register) may store the device location (or symbol positions) associated with the pattern. If a match occurs, this device (or symbol positions) are used as the marked locations in the correction. If an error was corrected (on same memory device), corresponding position flags are updated.

FIG. 3A illustrates an example logic structure 300A configured to perform pattern matching as described above. The logic structure 300A includes one or more memory address storage registers for storing actual memory addresses and comparison/analysis logic modules, as described below.

In the logic structure 300A, a current physical address register 302 stores a current physical address 303a (e.g., a string of 1s and 0s) that represents the memory address being accessed, for example, during the current read operation 202. Although, the current physical example address register 302 is illustrated as having a width of 6 bits, the embodiments may use registers having different widths.

By way of review, memory error pattern matching identifies whether the read operation is accessing a potentially problematic address range that has been marked due to previous memory error corrections. That is, based on the previous error corrections it is known that some data read from the memory device is corrupt. Using memory error pattern matching and device marking allows the memory device to be marked as failing, just this particular memory read (i.e., identified range of address spaces).

The identified range of address spaces may be a smaller address space than most actual memory addresses. For example, most memory addresses would have more than 6 bits. Accordingly, the embodiments apply to memory addresses and address spaces of widths greater than, or less than, 6 bits.

The current physical address 303a is compared with a captured address 304, in a captured address register 305 that stores a previously identified error pattern. That is, the captured address register 305 stores the address of the pattern of the first detected error. The captured address 304 serves as a reference point for identifying subsequent errors in the same address range. The comparison between the current physical address 303a and the captured address 304 determines if the current physical address 303a matches the address of any known failing address ranges.

If the previously identified error pattern at the captured address 304 is not a match, but errors were corrected from the marked device, the captured address 304 will be updated in the captured address register 305 to reflect this learning (e.g., a new error pattern).

A position flag register 306 stores position flags that indicate which memory address bit positions of the current physical address 303a are required for error pattern matching. The position flags refine the error pattern matching process by specifying which bits in the memory address are relevant for comparison. The position flag register 306 includes two sets of position flags: A first set of position flags 307a reflect an initial state of the error pattern. A second set of position flags 307b represent an updated state after detecting the errors.

An address comparison module 308 includes logic configured for comparing the current physical address 303a with the captured address 304. A position flag analysis module 310 includes logic for analyzing the results of the address comparison output from the address comparison module 308.

Outputs from the address comparison module 308 and outputs from the position flags register 306 are combined and provided as inputs to the position flags analysis module 310. As such, the position flags analysis module 310 determines whether the current physical address 303a matches the captured address 304 for the required bit positions, based on the initial state position flags 307a in the position flags register 306. If a match is detected, the system identifies the current physical address 303a as part of a failing address range.

A no-match indicator signal 312 output from the position flags analysis module 310 indicates when the current physical address 303a does not match the captured address 304 (i.e., no error patter match) for the required bit positions. If the error pattern is not a match, the no-match indicator signal 312 means that device marking will not be used and the memory error will be corrected using a standard ECC technique.

The address comparison module 308 and the position flags analysis module 310 update the content of the position flags register 306 based on detected errors to reflect the new learning. For example, if errors are corrected on the marked device, the initial state position flags 307a would be changed to the updated state position flags 307b. This dynamic update process ensures that the memory system 100 can accurately identify and handle failing address ranges in future read operations.

During an exemplary use case (e.g., during the current read operation 202), and prior to an error pattern being formed, the position flags register 306 reflects the initial state position flags 307a. That is, the position flag values are all zeros at the time of the current read operation 202, as depicted in FIG. 3A. Thus, since an error pattern was not formed, pattern matching was not achieved between the pattern at the current physical address 303a and the pattern represented by the captured address 304. Consequently, device marking would not be used as a result of the current read operation 202.

Assume, however, that the data read during the current read operation 202 included an error at bit positions 303a₀ and 303a₃ (reflected as zeros in each bit position). As a result, and by way of example, the position flags stored in the position flag register 306 would be changed to the second set of position flags reflecting the updated state position flags 307b. The updated state position flags 307b would be changed to reflect the bit positions where the pattern at the current physical address 303a matched the pattern represented by the captured address 304.

In the present exemplary use case, the address bit values (e.g., 100100) of the current physical address 303a (e.g., share the same bit values at the respective bit positions) and the address bit values (e.g., 101101) of the captured address 304 (error pattern) match at all bit positions except 303a₀/304₀ and 303a₃/304₃. (See FIG. 3A) As a result, bit positions 307b₀, 307b₃ in the updated state position flags 307b (e.g., 001001) are changed from zero (0) to one (1), corresponding to bit positions that did NOT match between the current physical address 303a and the captured address 304 (error pattern).

In FIG. 3B, the updated state position flags 307b bits with values of zero (0) means these bits are required. Bits with a value of one (1) means these bits are “don't care.” Therefore, during a future match attempt, the bit position bit positions 307b₀, 307b₃ of the updated state position flags 307b will be ignored. This means that if there is a match for any positions between the current physical address 303a and the captured address 304 at all positions EXCEPT the two bits positions 307b₀, 307b₃ in the updated state position flags 307b (i.e., 4 out of the 6 bits), a pattern match will be declared and noted with a match indicator signal 314.

In this manner, boundaries of the failing address ranges can be formed by turning on bits in the address that will be ignored. This is achieved by using the position flags register 306. Each of the address bits (e.g., represented by the position flags 307a, 307b, the current physical address 303a, etc.) corresponds to some region in the physical memory architecture within a memory array (e.g., a DRAM media 103).

FIG. 4 is an example illustration of failure locations in the memory architecture of the memory device. As indicated in FIG. 4, a physical address accounts for memory hierarchy 400 in the DRAM media 103 to yield most effective results. That is, the goal in the embodiments is to identify smallest region (i.e., number of address bits) required to completely bound the memory fail(s).

FIG. 4 illustrates an example of where failures 402 are contained in a single specific section 403 of the memory device. Only physical memory addresses matching that specific section 403 would use the device marking. Additional example address bits 404, 406, 408 correspond to rows 410 within the single section 403. All of the address bits 404, 406, 408 would eventually have a flag set in the position flag register 306.

An advantage of the approach illustrated in FIGS. 2-4 is that if an error is identified, the system will start by searching the smallest possible range. As more errors are identified, the space will be expanded, allowing the address space to be bounded where the errors are located.

In principle, if the total 2^{N} addresses were searched, that could amount to millions of addresses. Searching using conventional approaches would result in a high number of UEs, which is not an effective solution. By contrast, using the approach disclosed herein, memory addresses are examined on a per-bit basis by turning on the position flags. There are only a total of N number of address bits. Correspondingly, there are also N number of position flags. This means that we are using at most N different read attempts without the device marking.

The approach disclosed herein may be referred to as a bounded mistake technique. Therefore, there can never be more than N correction attempts. Even if the entire memory device failed, by using this the approach described in FIGS. 2-4, there would be a limit of N total attempts. N is generally on the order of maybe 15-20, which is small in comparison to the failure rate for most non-deterministic ECC solutions. This approach provides up to 20 correction attempts, resulting in a comparatively low cumulative probability of generating a UE. The basic idea behind the approach described herein is to use as few resources as possible or limit the error corrections to as small an address radius as possible, without risking being wrong so many times that a UE is generated.

The embodiments provide methods to successfully correct errors when either an entire device has failed or an entire read access to a device is corrupt using less costly (in terms of parity/die overhead) ECC schemes. The embodiments also provide a streamlined solution for minimizing the cumulative decoder failure probability due to multiple non-deterministic error corrections while avoiding unnecessarily reducing the correction capabilities of the code for most addresses.

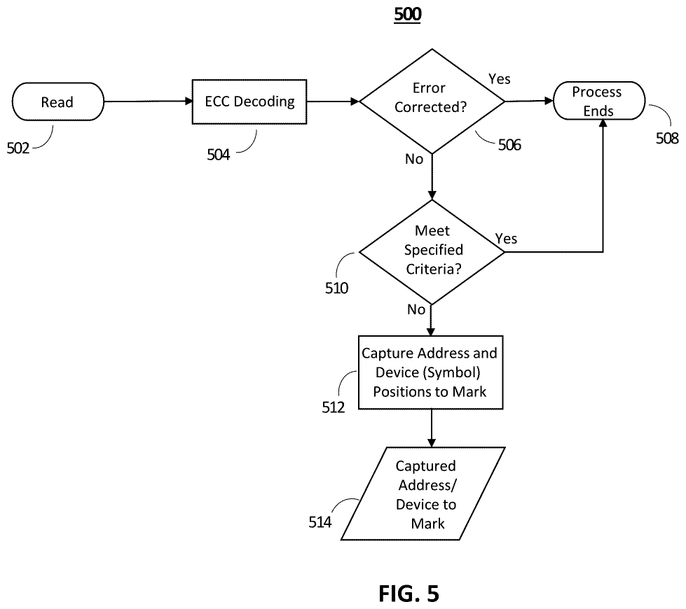

FIG. 5. illustrates an example method 500 of capturing an initial error address, where failures are contained to the single section 403 in one bank, such as bank 6 within the memory hierarchy 400.

As depicted in the method 500 of FIG. 5, the process is triggered by initial error address capture. The address capture occurs when a corrected error meets some criteria. For example, there may be certain number of symbol errors in a codeword from a single memory device. The captured address is used as shown in FIG. 2-4 for subsequent pattern matching. A device (or symbol positions) that is to be marked must be associated with a captured address and position flags. In this manner, once an address matches an existing pattern the marking information to use is available.

The method 500 begins in block 502 by initiating a memory read operation 502 to capture the address of an error pattern when a corrected error meets specified criteria. The read operation 502 activates ECC decoding 504, where the system attempts to decode the data read from the memory device during the memory read operation 502.

In block 506, the system checks if an error was identified and corrected during the ECC decoding 504. If an error was corrected, the process ends at block 508. If the error was detected but not corrected, the method 500 proceeds to block 510 to determine if the error meets specified criteria. By way of example only, and not limitation, this criteria may involve detecting a certain number of symbol errors in a codeword from a single memory device.

If the error does not meet the specified criteria, the method 500 ends at block 508. If the error meets the specified criteria, the process ends at block 508. In the error fails to meet the specified criteria, the method 500 proceeds to block 512 to capture the address and device (symbol) positions to mark. This action block involves, for example, storing the captured address in the captured address register 500, representing the address location where the initial error was detected. As described above, the captured address is used for subsequent pattern matching.

In block 514, the method 500 stores the captured address and device (symbol) positions to mark. This action block ensures that once an address (i.e., the captured address 304) matches an existing pattern, the system knows which device or symbol positions to mark for subsequent correction attempts. The captured address and device to mark are then used in future read operations to enhance the system's ability to correct errors deterministically.

The embodiments may also be applied to multiple patterns. That is, it is possible to implement multiple pattern matches in parallel so that multiple devices (up to all devices) could have a unique pattern associated with that device. The pattern matching performed in the embodiments leverage knowledge of internal DRAM (or other memory) physical layout along with a simple algorithm to intelligently apply device marking for erasure decoding (or similar techniques) to a minimum set of addresses where the error may be included.

Unlike conventional approaches, the embodiments avoid marking an entire device unless failures span the entire device. The embodiments also reserve more powerful error correction capabilities for most address space and require relatively little hardware to implement. There is no need to store large list of bad addresses and there is a (low) bounded number of non-deterministic correction attempts. The embodiments also limit cumulative decoder failure probabilities due to repeated reads on addresses with errors

The present approach can readily be extended to mark different address regions on different devices and enables correction even if two or more devices have all symbols corrupted in some codewords, as long as the address ranges for those codewords do not overlap. Thus, the embodiments enable different address ranges to be identified as failing on different devices, further reducing the UE probability.

The various features of the embodiments described herein collectively provide a more efficient and reliable method for error correction in memory systems, addressing the limitations of existing solutions and offering significant improvements in terms of error correction capability and hardware efficiency. The embodiments also require relatively little hardware to implement, avoiding the need to store large lists of bad addresses and instead using simple registers and combinational logic gates.

For example, the size of the failing address space can range from a single address to an entire device, but only two registers and some simple combinational logic gates are required to identify which addresses should be identified as failing on a specific device for subsequent correction attempts.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A memory system comprising:
logical to physical memory address translation logic to build up a minimum address space containing a memory device address with defects, the translation being based on memory correction attempts;
wherein for each correction attempt, the logical address is first translated to a memory device physical address;
wherein bit positions at the physical address are compared with an existing error bit pattern to determine if marking should be applied to the memory device; and
wherein if the bit positions do not match the existing error bit pattern, but errors are corrected from the marked memory device, the existing error bit pattern will be updated to reflect a new error bit pattern.

2. The memory system of claim 1, wherein an attempt is a memory read associated with a non-zero syndrome.

3. The memory system of claim 1, wherein the existing error bit pattern is stored in a register within the memory device.

4. The memory system of claim 1, wherein the logical to physical address translation logic leverages knowledge of the logical to physical address mapping to ensure accurate data retrieval from the correct physical location in the memory device.

5. The memory system of claim 1, wherein the comparing involves comparing the translated physical address with previously detected error locations or failing memory address ranges.

6. The memory system of claim 1, wherein the system updates the existing pattern based on newly detected errors to enhance the system's ability to handle errors over time.

7. The memory system of claim 1, wherein the system uses the new error bit pattern for subsequent read operations to improve the overall reliability of the memory system.

8. The memory system of claim 1, wherein the system performs error correction without device marking if the existing error bit pattern does not match any known error patterns.

9. The memory system of claim 1, wherein the system treats data from the identified failing address range as erasures during error correction to enhance error correction capability.

10. The memory system of claim 1, wherein the system uses position flags to indicate which memory address bit positions are required for error pattern matching.

11. A method for managing memory errors in a memory system, the method comprising:
translating a memory device logical memory address to a physical address for each memory correction attempt;
comparing bit positions at the physical address with an existing error bit pattern to determine if marking should be applied to the memory device;
applying marking to the memory device if the bit positions at the physical address match the existing error bit pattern;
updating the error bit pattern if the bit positions at physical address do not match the existing error bit pattern but errors are corrected from the marked device; and
using the updated error bit pattern for subsequent memory correction attempts to enhance error correction capability.

12. The method of claim 11, wherein an attempt is a memory read associated with a non-zero syndrome.

13. The method of claim 11, wherein the existing pattern is stored in a register within the memory device.

14. The method of claim 11, wherein the logical to physical address translation logic leverages knowledge of the logical to physical address mapping to ensure accurate data retrieval from the correct physical location in the memory device.

15. The method of claim 11, wherein the pattern matching process involves comparing the translated physical address with previously detected error locations or failing memory address ranges.

16. The method of claim 11, wherein the method updates the existing pattern based on newly detected errors to enhance the system's ability to handle errors more effectively over time.

17. The method of claim 11, wherein the method uses the updated pattern for subsequent read operations to improve the overall reliability of the memory system.

18. The method of claim 11, wherein the method performs error correction without device marking if the pattern does not match any known error patterns.

19. The method of claim 11, wherein the method uses position flags to indicate which memory address bit positions are required for error pattern matching.

20. A non-transitory computer-readable medium storing instructions that, when executed by a processor, cause the processor to perform a method for managing memory errors in a memory system, the method comprising:
translating a memory device logical memory address to a physical address for each memory correction attempt;
comparing bit positions at the physical address with an existing error bit pattern to determine if marking should be applied to the memory device;
applying marking to the memory device if the bit positions at the physical address match the existing error bit pattern;
updating the error bit pattern if the bit positions at physical address do not match the existing error bit pattern but errors are corrected from the marked device; and
using the updated error bit pattern for subsequent memory correction attempts to enhance error correction capability.
